(19) United States
(12) Patent Application Publication
(10) Pub. No.: US 2006/0082963 A1
(43) Pub. Date: Apr. 20, 2006

(54) USB drive mass storage device with means for holding memory cards not in use

(76) Inventor: I-Ming Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/964,666

(22) Filed: Oct. 15, 2004

(51) Int. Cl. G06F 1/16

(52) U.S. Cl. 361/684

(57) ABSTRACT

A USB drive mass storage device has a housing provided at an end with, for example, a USB connector, and at the other end with at least one card slot for different types of memory cards, such as SD, mini SD, MMC cards, etc. At least one side of the housing is provided with a receiving space openably closed with a cover for holding memory cards not in use. When a memory card is currently not in use, it may be conveniently positioned in the receiving space on the housing of the USB drive mass storage device without the risk of being carelessly lost or discarded.

### FIELD OF THE INVENTION

The present invention relates to a USB drive mass storage device with means for holding memory cards not in use, and more particularly to a USB drive mass storage device that facilitates easy carrying of multiple memory cards storing a large quantity of data for freely connecting to a computer or other electronic products.

### BACKGROUND OF THE INVENTION

Memory cards of different manufacturers, different sizes, and different reading manners have been developed and widely employed among consumers. And, it is possible a general consumer owns more than one memory card at the same time. Therefore, most computer-related electronic products are provided with one or more slots adapted to one or more types of memory cards, so as to enable easy access of a large amount of data stored on different memory cards. Conventional USB drive mass storage devices are also developed based on this principle.

Most conventional USB drive mass storage devices, in addition to necessary internal electronic elements thereof, are provided at one end with a universal serial bus (USB) connector, and at the other end with one or more card slots for one or more types of memory cards (such as SD, mini SD, MMC cards, etc.) to plug therein to enable storing or reading of large quantity of data into or from the memory cards. Memory cards that are not plugged in a USB drive mass storage device and currently not in use are not always collectively received or positioned at a fixed place, and therefore could not be conveniently located or maintained in good condition when they are to be used next time.

It is therefore tried by the inventor to develop a USB drive mass storage device with means for holding memory cards not in use to overcome the above problem with the memory cards that are often scattered when they are not in use.

### SUMMARY OF THE INVENTION

A primary object of the present invention is to provide a USB drive mass storage device that is provided with at least one receiving space for holding one or more memory cards that are not in use, so that the memory cards not in use could be collectively received in the USB drive mass storage device without being carelessly scattered or lost.

To achieve the above and other objects, the USB drive mass storage device according to the present invention has a housing provided at an end with, for example, a USB connector, and at the other end with at least one card slot for different types of memory cards, such as SD, mini SD, MMC cards, etc. At least one side of the housing is provided with means for holding memory cards not in use, which includes a receiving space openably closed with a cover for holding memory cards not in use. When a memory card is currently not in use, it may be conveniently positioned in the receiving space on the housing of the USB drive mass storage device without the risk of being carelessly lost or discarded.

The means for holding memory cards not in use may be provided at two sides of the housing of the USB drive mass storage device, so that memory cards of different brands and sizes may be separately positioned. And, the cover of the receiving space is pivotally connected at an edge to one side of the receiving space to be conveniently opened or closed.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a top perspective view of a USB drive mass storage device with means for holding memory cards not in use according to a first embodiment of the present invention, wherein a cover of a first memory card holding means is in an opened position;

FIG. 2 is a partially sectioned side view of FIG. 1 with the cover of the first memory card holding means in a closed position;

FIG. 3 is a bottom perspective view of the USB drive mass storage device of FIG. 1 with a cover of a second memory card holding means in an opened position;

FIG. 4 is a side view showing the USB drive mass storage device of FIG. 1 with memory cards removed from the memory card holding means and plugged in card slots;

FIG. 5 is a perspective view of a USB drive mass storage device with means for holding memory cards not in use according to a second embodiment of the present invention; and

FIG. 6 is a perspective view of a USB drive mass storage device with means for holding memory cards not in use according to a third embodiment of the present invention.

### DETAILED DESCRIPTION OF THE PREFERRED EMBODIMENTS

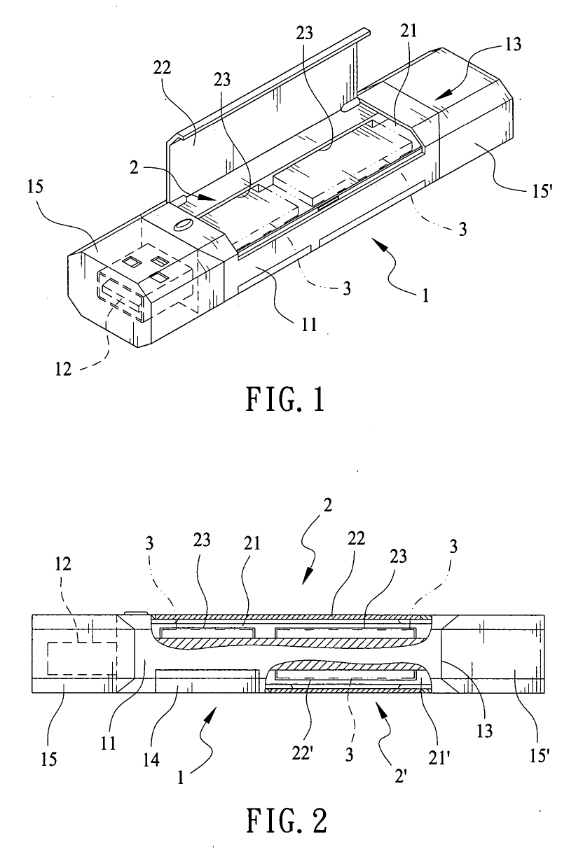

Please refer to FIGS. 1, 2, and 3, which are top perspective view, partially sectioned side view, and bottom perspective view, respectively, of a USB drive mass storage device with means for holding memory cards not in use according to a first embodiment of the present invention.

As shown, the USB drive mass storage device, which is generally denoted by reference number 1, includes a housing 11 having necessary electronic elements mounted therein, and being provided at a first end with a connector 12, such as a universal serial bus (USB) connector, at a second end opposite to the first end with at least one memory card slot 13 for different types of memory cards, such as SD, mini SD, MMC, etc., to insert thereinto. As can be seen from FIG. 2, it is also possible to provide an extra memory card slot 14 at one side of the housing 11. End caps 15, 15′ are selectively provided to protectively cover the first and the second end with the connector 12 and the memory card slots 13, respectively. In addition to the electronic elements required for the USB drive mass storage device to function normally, other electronic elements providing different functions, such as MP3, AM/FM, audio recording, etc., may be optionally mounted in the housing 11.

The housing 11 of the USB drive storage device 1 is provided at, for example, an upper side with a first means for holding memory cards not in use, which is generally denoted by reference number 2 and also referred to as first memory card holding means 2 for the purpose of simplicity. The first memory card holding means 2 includes an open-topped recess 21 openably closed with a cover 22 and divided into one or more locating cavities 23 for separately firmly holding one memory card 3 each. The locating cavities 23 may be differently sized to adapt to different types of memory cards 3. The cover 22 is a flat plate pivotally connected at an edge to one side of the recess 21 and accordingly, the housing 11, so as to be conveniently opened or closed.

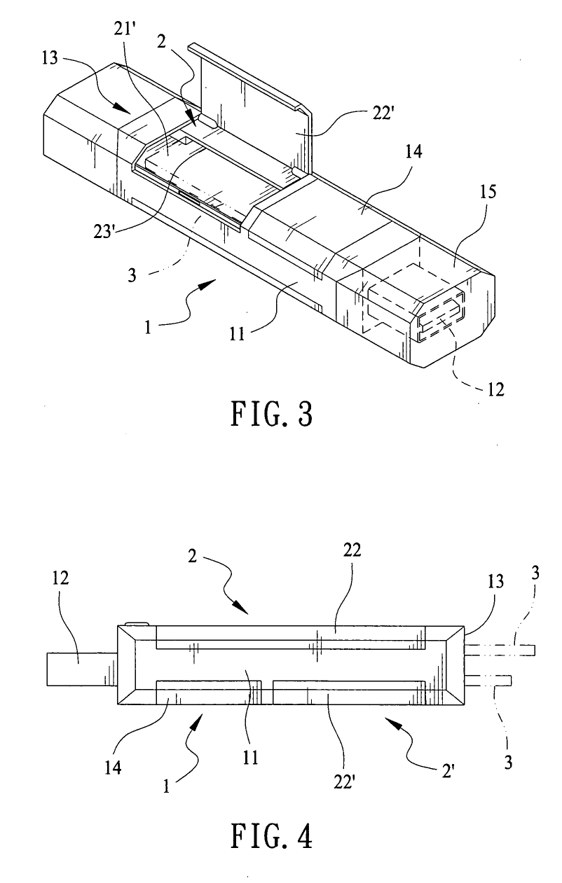

As can be seen from FIGS. 2 and 3, the housing 11 may also be provided at a lower side with a second means for holding memory cards not in use 2′ (also referred to as second memory card holding means 2′ for simplicity) having a structure similar to that of the first memory card holding means 2. That is, the memory card holding means 2′ includes an open-topped recess 21′ openably closed with a cover 22′ and divided into one or more locating cavities 23′ for separately firmly holding more memory cards 3 of different manufacturers, versions, or types that are not in use.

FIG. 4 is a side view showing the USB drive mass storage device 1 of the present invention with memory cards 3 removed from the memory card holding means 2, 2′ and plugged in the memory card slots 13 at the second end of the housing 11 or the extra memory card slot 14 at one side of the housing 11.

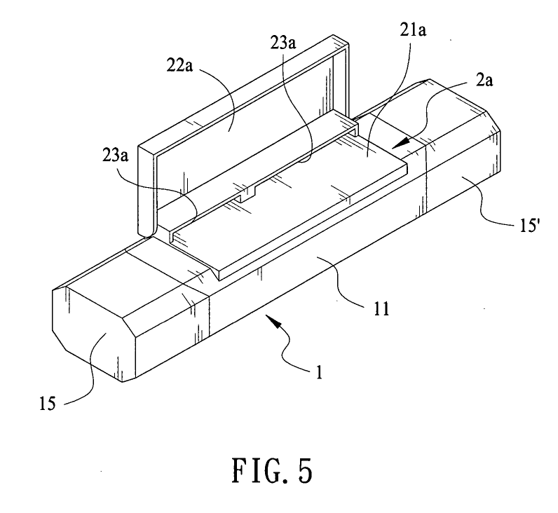

FIG. 5 is a perspective view of a USB drive mass storage device 1 with means for holding memory cards not in use according to a second embodiment of the present invention. The means for holding memory cards not in use in the second embodiment is generally denoted by reference number 2a and also referred to as the memory card holding means 2a for simplicity, and includes at least one raised open-topped seat 21a provided at one or two sides of the housing 11. The seat 21a is openably closed with a cover 22a and divided into one or more locating cavities 23a for holding different types of memory cards not in use.

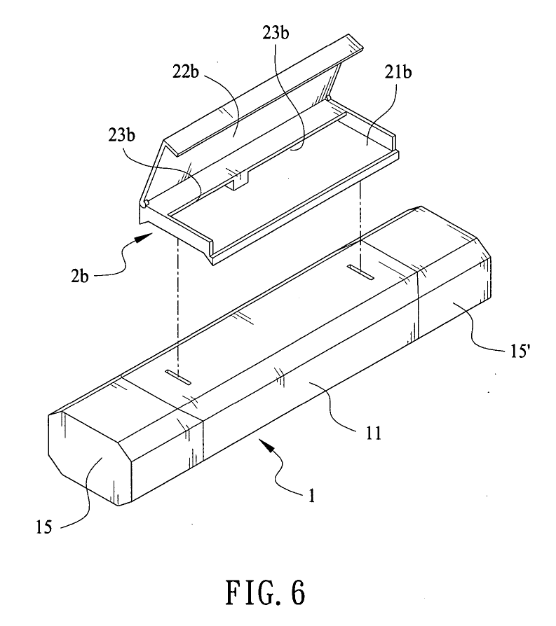

FIG. 6 is a perspective view of a USB drive mass storage device 1 with means for holding memory cards not in use according to a third embodiment of the present invention. The means for holding memory cards not in use in the third embodiment is generally denoted by reference number 2b and also referred to as the memory card holding means 2b for simplicity, and includes at least one case 21b removably connected to one or two sides of the housing 11. The case 21b includes a cover 22b pivotally connected at an edge to a predetermined position of the case 21b to openably close the case 21b. The case 21b is internally divided into one or more locating cavities 23b for holding different types of memory cards not in use.

When a memory card 3 is unplugged from the card slot 13 or the extra card slot 14 on the USB drive mass storage device 1, it may be conveniently positioned in the memory card holding means 2, 2′, 2a, or 2b at a locating cavity 23, 23′, 23a, or 23b corresponding to the type or size of the unplugged memory card 3, so that the memory card 3 could be carefully stored without the risk of being carelessly lost or discarded. On the other hand, a user may easily pick up a desired one of the memory cards 3 from the locating cavities 23, 23′, 23a, or 23b of the memory card holding means 2, 2′, 2a, or 2b for use.

What is claimed is:

1. A USB drive mass storage device with means for holding memory cards not in use, comprising:
a USB drive mass storage device having a housing with necessary electronic elements mounted therein; said housing being provided at a first end with an electric connector, and at a second end opposite to said first end with at least one card slot; and
means for holding memory cards not in use provided at one or more predetermined positions on said housing of said USB drive mass storage device; and each of said means for holding memory cards not in use including a receiving space openably closed with a cover.

2. The USB drive mass storage device with means for holding memory cards not in use as claimed in claim 1, wherein said receiving space of each said means for holding memory cards not in use is an open-topped recess formed on said housing and openably closed with said cover.

3. The USB drive mass storage device with means for holding memory cards not in use as claimed in claim 1, wherein said receiving space of each said means for holding memory cards not in use is a raised open-topped seat formed on said housing and openably closed with said cover.

4. The USB drive mass storage device with means for holding memory cards not in use as claimed in claim 1, wherein said receiving space of each said means for holding memory cards not in use is a case removably connected to said housing and openably closed with said cover.

5. The USB drive mass storage device with means for holding memory cards not in use as claimed in claim 1, wherein said receiving space of each said means for holding memory cards not in use is internally formed of at least one locating cavity for firmly holding one memory card each.

6. The USB drive mass storage device with means for holding memory cards not in use as claimed in claim 2, wherein said receiving space of each said means for holding memory cards not in use is internally formed of at least one locating cavity for firmly holding one memory card each.

7. The USB drive mass storage device with means for holding memory cards not in use as claimed in claim 3, wherein said receiving space of each said means for holding memory cards not in use is internally formed of at least one locating cavity for firmly holding one memory card each.

8. The USB drive mass storage device with means for holding memory cards not in use as claimed in claim 4, wherein said receiving space of each said means for holding memory cards not in use is internally formed of at least one locating cavity for firmly holding one memory card each.

9. The USB drive mass storage device with means for holding memory cards not in use as claimed in claim 1, wherein said cover for closing said receiving space of each said means for holding memory cards not in use is a flat plate pivotally connected at an edge to one side of said receiving space.

10. The USB drive mass storage device with means for holding memory cards not in use as claimed in claim 2, wherein said cover for closing said receiving space of each said means for holding memory cards not in use is a flat plate pivotally connected at an edge to one side of said receiving space.

11. The USB drive mass storage device with means for holding memory cards not in use as claimed in claim 3, wherein said cover for closing said receiving space of each said means for holding memory cards not in use is a flat plate pivotally connected at an edge to one side of said receiving space.

12. The USB drive mass storage device with means for holding memory cards not in use as claimed in claim 4, wherein said cover for closing said receiving space of each said means for holding memory cards not in use is a flat plate pivotally connected at an edge to one side of said receiving space.
